(19) United States
(12) Patent Application Publication
(10) Pub. No.: US 2012/0279348 A1
(43) Pub. Date: Nov. 8, 2012

(54) Motorcycle Lever Protection Guard

(76) Inventor: Eric Wood, Winchendon, MA (US)

(21) Appl. No.: 13/443,976

(22) Filed: Apr. 11, 2012

Related U.S. Application Data
(60) Provisional application No. 61/518,316, filed on May 4, 2011.

(51) Int. Cl. B62J 23/00

(52) U.S. Cl. 74/551.8

(57) ABSTRACT

A lever guard for handlebar of a motorcycle that includes a clamp, secured to the cylindrical surface of the handlebar of the motorcycle, and a guard portion that is bolted to the clamp. The clamp is placed outside of the grips of the motorcycle. The guard provides protection for both the clutch and brake levers of the motorcycle, which are generally mounted on the handlebar of conventional motorcycles. When riding a motorcycle, a rider may accidentally come into contact with either stationary objects, other riders, or other vehicles, resulting in the accidental application of the brake or clutch lever. In competition, this contact is quite frequent. The lever guard helps to prevent this contact by serving as a barrier between the clutch or brake lever and any other rider or object.

### CONTINUITY DATA

This is a non-provisional application of provisional application number 61518316, filed on May 4, 2011, and priority is claimed thereto.

### FIELD OF THE PRESENT INVENTION

The present invention relates generally to the field of motorcycle safety. More specifically, the present invention relates to a motorcycle lever protection guard device. Moreover it pertains specifically to such apparatus for a Motorcycle Lever Protection Guard that allows for the guard to be attached to the cylindrical handlebar surface of the motorcycle, forming a protective barrier around the hand levers of the motorcycle, preventing accidental contact.

### BACKGROUND OF THE PRESENT INVENTION

As with most vehicles, safe operation is paramount. Motorcycle riding presents some unique risks because the controls of the machine are exposed to the elements. Even trained riders on a closed course often encounter dangerous situations, where split-second decisions must be made, or else a crash will occur. Sometimes, crashes that occur during professional motorcycle races are caused when one rider comes into contact with another rider.

Despite new safety measures and the training that racers receive, motorcycle racing accidents still occur during nearly every racing competition. Riders riding too close together, especially highly competitive riders on a tight track, may touch, potentially causing both motorcycles to crash, or to become unstable. In these cases, the point of contact between the two riders sometimes occurs as the end of one rider's motorcycle handlebar comes into contact with another rider's motorcycle, often near the grip and levers. In several documented cases, this contact has activated a lever, or torn the lever off. If the right lever, conventionally functioning as the brake lever, of a motorcycle is activated by accident or without intention from a nearby rider, the brakes of the motorcycle are activated. This will often abruptly cause a crash. The left lever conventionally functions as a clutch lever, which is also dangerous to activate accidently. There have been many cases where accidental contact has broken the clutch lever off, making it very difficult to shift the motorcycle. While lever protection guards have been created to alleviate this issue, conventional lever protection guards are often mounted in poor locations and are highly susceptible to damage and are non-adjustable, leaving much to be desired.

Unfortunately, when a motorcycle is crashed, it often skids across the ground until the forces of friction bring the motorcycle to a halt. In this process, certain portions of the motorcycle are in contact with the ground. Most often these points of contact include two or more of the following: the edge of the handle bars, a front fairing, the exhaust, the mirrors, and/or the foot pegs. In the likely event that the motorcycle skids to a stop on the handlebar, often the ends of the handlebar or the brake and clutch levers (often composed of fragile aluminum) are worn down or broken as the motorcycle skids across the ground (usually composed of abrasive asphalt or cement). Many lever protection guards have been devised in an attempt to protect the conventional brake and clutch levers found on the right and left sides of a conventional motorcycle's handlebar. These are typically mounted to the end of the handlebar, which is a common contact point in the event that the motorcycle falls over or is laid down. As a result of this skidding and grinding involved in crashes, the mounting portion of the protection guard is usually destroyed by the asphalt or cement as well, making it difficult to remove by conventional tools after the wreck.

Thus, there is a need for a guard designed to protect the brake and clutch levers of a motorcycle from accidental contact without employing the end face of a motorcycle's handlebar, thus ensuring easy removal of the guard from the handlebar after a crash.

U.S. Pat. No. 7,611,186, granted to Paul Degarate et al issued on Nov. 3, 2009, is for an Integrated Hand and Controls Protection System. Degarate et al incorporates a protection system into a fairing that spans the width of a motorcycle's handlebar and is mounted into the core of the handlebar on both ends. Unlike the present invention, Degarate et al cannot be removed easily in the event that the motorcycle sustains damage, as its mounting point is often destroyed.

Patent Publication No: US2009/0314125A by Mentasti, published on Dec. 24, 2009, is for a Hand Guard for Motorcycle Handlebar. While Mentasti provides a means of guarding the hands and levers of a motorcycle, Mentasti is not adjustable or sizable to fit multiple motorcycles.

U.S. Pat. No. 4,141,567, filed by Scott and issued on Feb. 27, 1979 is for Handlebar Hand Guards. Scott is similar to the present invention, however it is functionally more limited. Scott does not maintain the ability to be universally secured to the cylindrical surface of the handlebar in a single location outside of the handle grip. Additionally, Scott can be too large to be used on modern motorcycles without interfering with the gauges or fairings of the motorcycle.

Patent Publication No: US2010/0180716A1, published on Jul. 22, 2010, and filed by Brumana et al is for a Protection Device with Aerodynamic Effect for a motor Vehicle, which offers similar protection for the levers of a motorcycle, however, unlike the present invention, the device by Brumana et al is secured to the tip or end of the handlebar. This type of attachment requires special adapters to fit different types of motorcycles—and more specifically, the interior diameters of the handlebar of each different motorcycle—adding to the complexity and cost of the assembly. Brumana et al also does not allow the end of the handlebar to serve as any type of protection for the device, leaving the guard more exposed to damage in the event of a crash. Unlike the present invention, Brumana et al does not have the capacity to be universally secured to the cylindrical surface of the handlebar in a single location outside of the handle grip.

A common device in the market to protect levers consists of a guard that bolts on the end of the handlebar in two places; both on the end of the bar, and again on the inside of the bar. While this device offers excellent protection, space constraints on modern motorcycles prevent the use of this type of device due to interference with the gauges or fairings.

Many devices have been proposed for the protection of the levers of a motorcycle. All of the prior art either attaches to the end of the handlebar, or is integrated into a protective fairing that spans across the handlebar assembly. The market for motorcycle lever protection guards contains many different handlebar designs. Thus, there is a need for a more universal clamp or mount that targets the generally typical aspects of handlebars not currently being addressed in the prior art.

It is therefore an object of the present invention to provide an improved, more universal apparatus for use in protecting the levers from accidental contact without the present size limitations, mounting limitations, and lack of protection from damage of the prior art.

### SUMMARY OF THE PRESENT INVENTION

In view of the limitations now present in the prior art, the present invention is a new and useful motorcycle lever protection guard that is simpler in construction, more universally usable, and more versatile in operation than any known apparatus of this kind.

The purpose of the present invention is to protect the brake and clutch levers conventionally mounted on the handlebar of a motorcycle. The present invention is intended to protect said brake and clutch levers from damage or accidental activation or breakage by a foreign object or the ground. The present invention exhibits many novel features not offered by similar lever protectors referenced in the prior art. These new features result in a motorcycle lever protection guard which is not apparent, obvious, or suggested, either directly or indirectly by any of the prior art apparatus.

The present invention is generally comprised of a body and clamp. The clamp serves to mount the present invention such that it is secured to the cylindrical surface of the handlebar of a motorcycle without interfering with the end points of the handlebar, found at either side. The guard arm is then mounted to the clamp, preferably via two bolts. The clamp portion is able to receive the motorcycle handlebar itself, and is preferably tightened and secured via screws on the clamp. The clamp is positioned on the handlebar outside of the hand grips, allowing the guard to provide protection to the levers from both side and frontal impacts. The handlebar protrudes beyond the clamp, causing the end of the handlebar to serve as the initial contact point with the ground in a crash, protecting the clamp from damage. The present invention does not interfere with the core or inner diameter of the handlebar to be secured in place, unlike conventional lever protectors.

The clamp serves as a mount for the guard arm of the present invention. The guard arm takes the brunt of the impact in a crash, and also serves to protect the levers from accidental activation, preventing potential crashes.

The foregoing has outlined, in general, the physical aspects of the invention and is to serve as an aid to better understanding the more complete detailed description that is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. exhibits a perspective view of a Motorcycle Lever Protection Guard according to the present invention.

FIG. 2. displays an exploded view of a Motorcycle Lever Protection Guard according to the present invention.

FIG. 3. shows a top view of a Motorcycle Lever Protection Guard according to the present invention.

FIG. 4. presents a front view of a Motorcycle Lever Protection Guard according to the present invention.

FIG. 5. is a side view of a Motorcycle Lever Protection Guard according to the present invention.

FIG. 6. is a perspective view of the present invention seen in FIG. 1.

FIG. 7 displays an alternate embodiment of the present invention that does not employ fasteners.

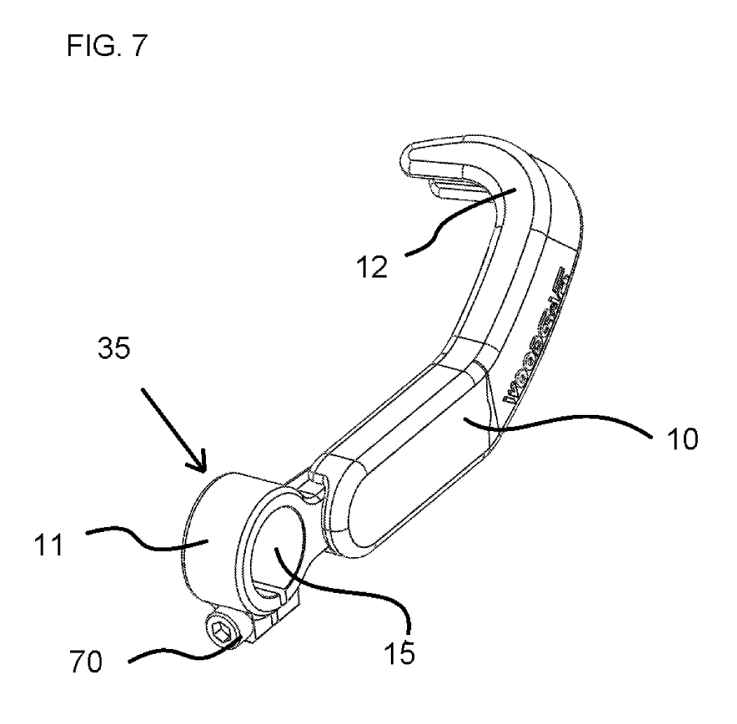

FIG. 8 shows an embodiment of the present invention featuring only one fastener.

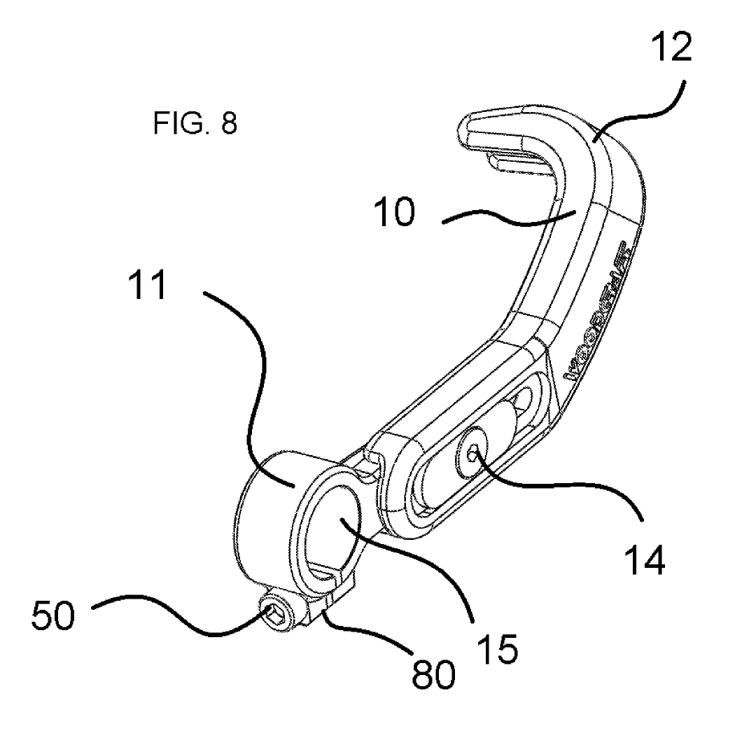

FIG. 9 exhibits an exploded view of a third alternate embodiment of the present invention.

FIG. 10 features an exploded view of an alternate embodiment of the present invention, outlining the ‘ID bar engagement’ method of securing the present invention to a handlebar.

FIG. 11 displays an alternate embodiment of the present invention, featuring the ‘ID bar engagement’ mounting.

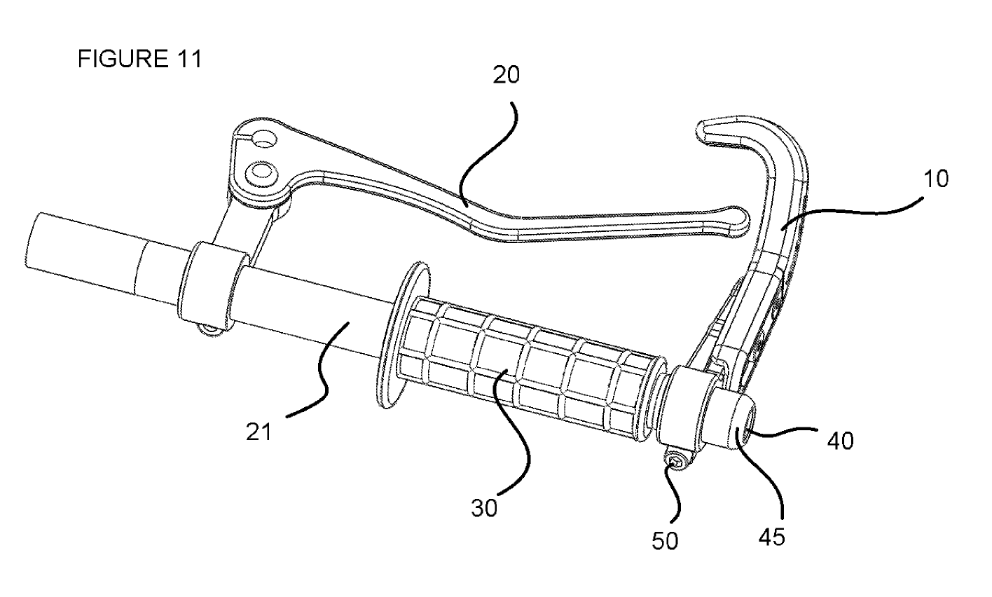

FIG. 12 is a view of a unitary alternate embodiment of the present invention.

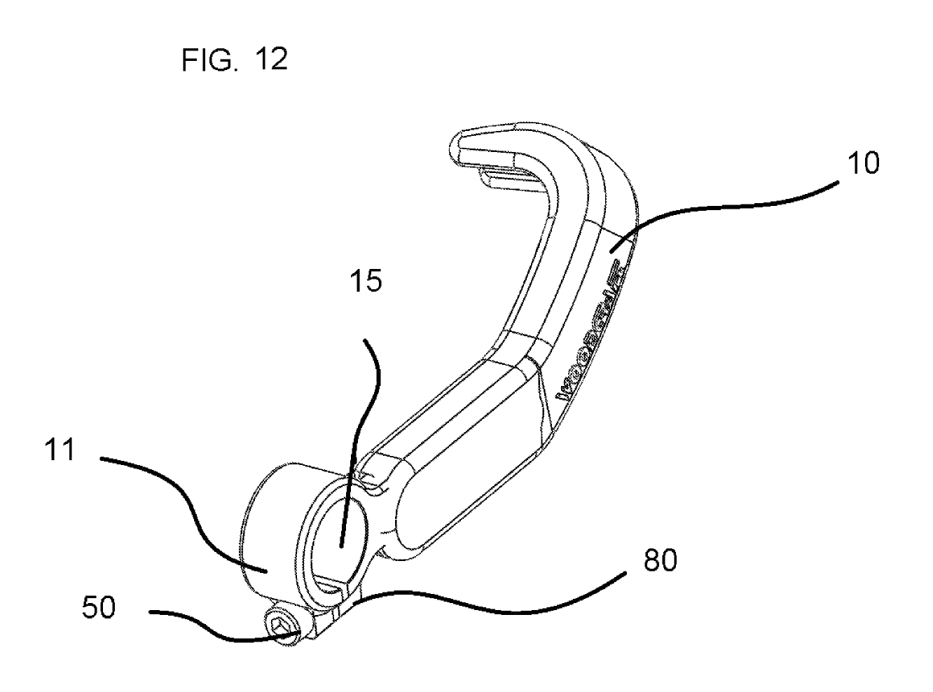

### DETAILED DESCRIPTION OF THE PREFERRED EMBODIMENT

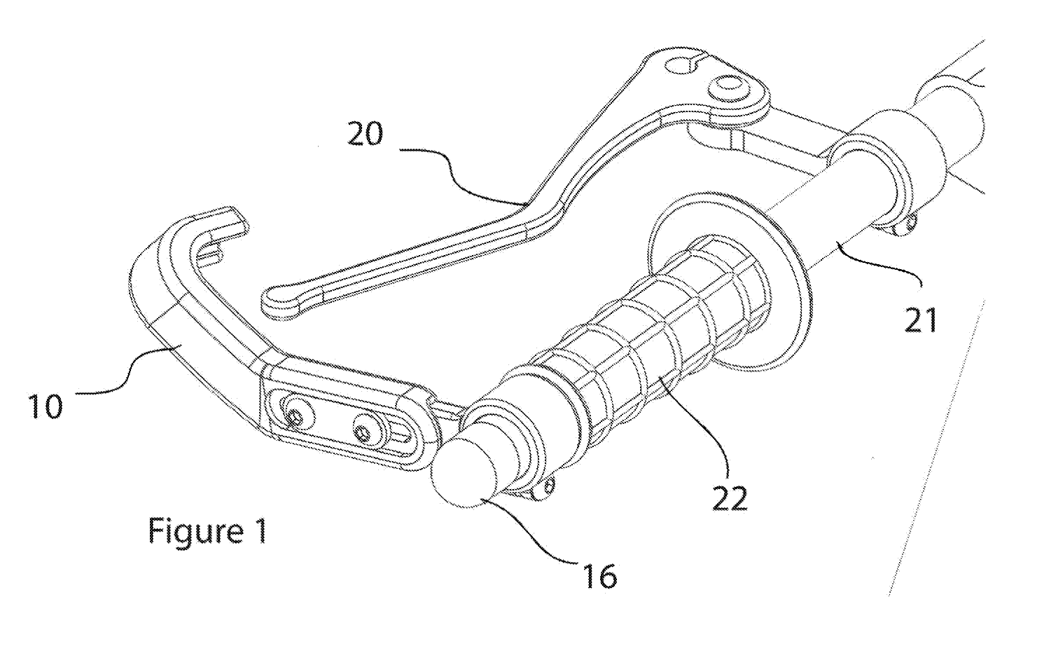

FIG. 1 illustrates the present invention as it is secured to the handlebar of a motorcycle, and shows the present invention protecting the lever (20) from both frontal and side impact. The present invention is envisioned to be installed on both the left end and the right end of a motorcycle's handlebar. The left guard is a mirror image of the right guard.

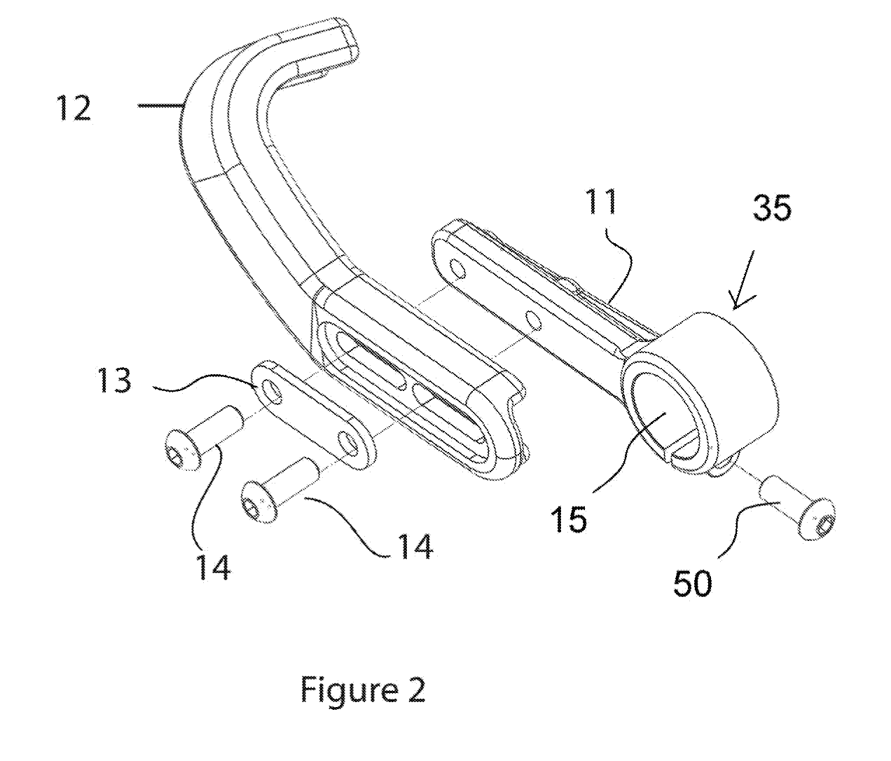

The guard arm (10) of the present invention is designed to protect the lever (20) from both front and side impacts as shown in FIG. 1. FIG. 2 shows the general layout of the preferred embodiment of the present invention, which includes a clamp (11) and a guard arm (10). The guard arm (10) can be bolted to the clamp (11) in multiple locations, resulting in an overall assembly that can be adjusted for length. The guard arm (10) is secured to the clamp (11) with conventional fasteners (14). The clamp (11) serves as the base or foundation of the present invention, ensuring that the present invention remains firmly in place on the handlebar (21). When properly mounted, the guard arm (10) has a hook (12) that curves inward toward the center of the handlebar (21), serving to curve around and protect the levers (20), while leaving adequate room for deliberate operation of the levers (20) by the rider's hands.

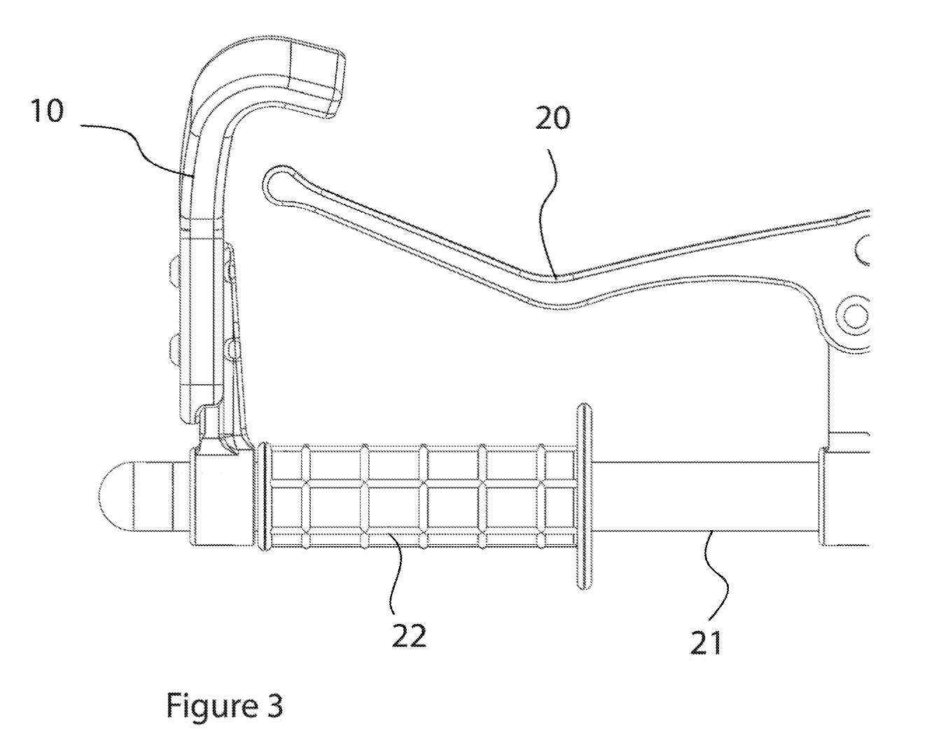

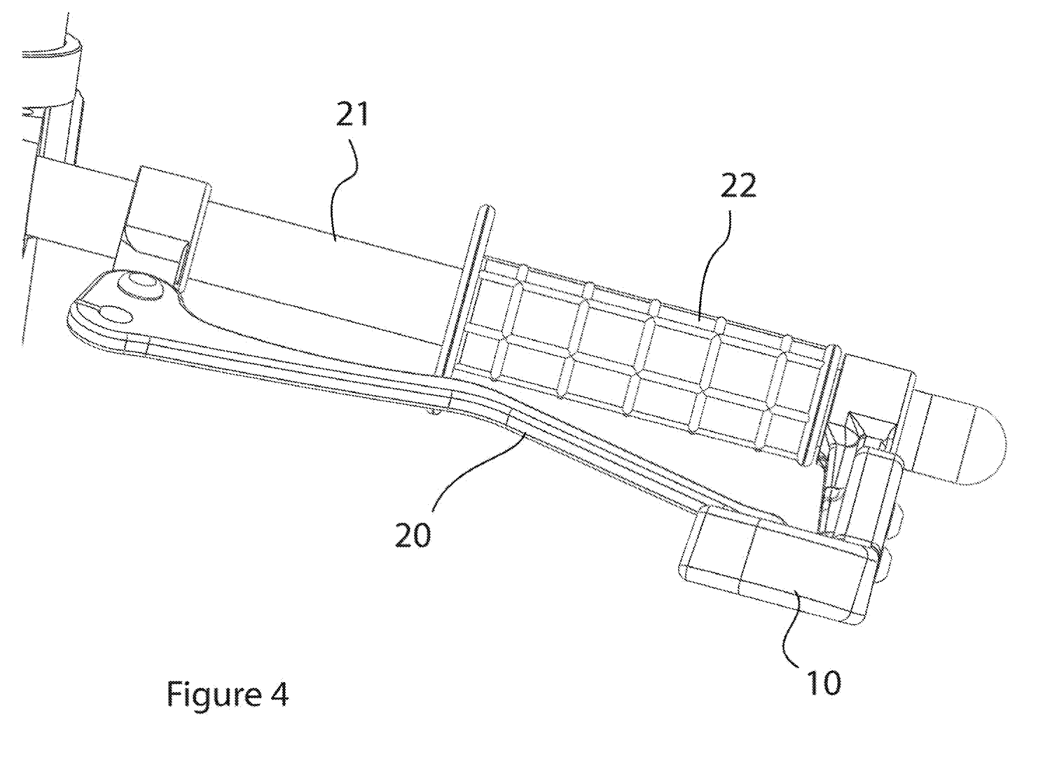

FIG. 3 and FIG. 4 display the preferred embodiment of the present invention, demonstrating the capacity of the present invention to protect the end of the lever (20) from accidental contact both from the front and the side. The handlebar (21) passes through the body (10) of the present invention and protrudes further to the outside edge of the present invention in order to serve to protect the clamp (11) of the present invention from damage in the event of a crash. FIG. 1 shows the end of the handlebar (16) clearly extending past the outside surface of the clamp (11) of the present invention. The clamp (11) of the present invention may be lined with a scratch resistance material, such as a rubber or thin layer of high density plastic to aide grip (30) as well as to ensure the clamp (11) of the present invention does not scratch the cylindrical surface of the handlebar (21) when installed. However, the preferred embodiment of the present invention does not employ such a protective coating.

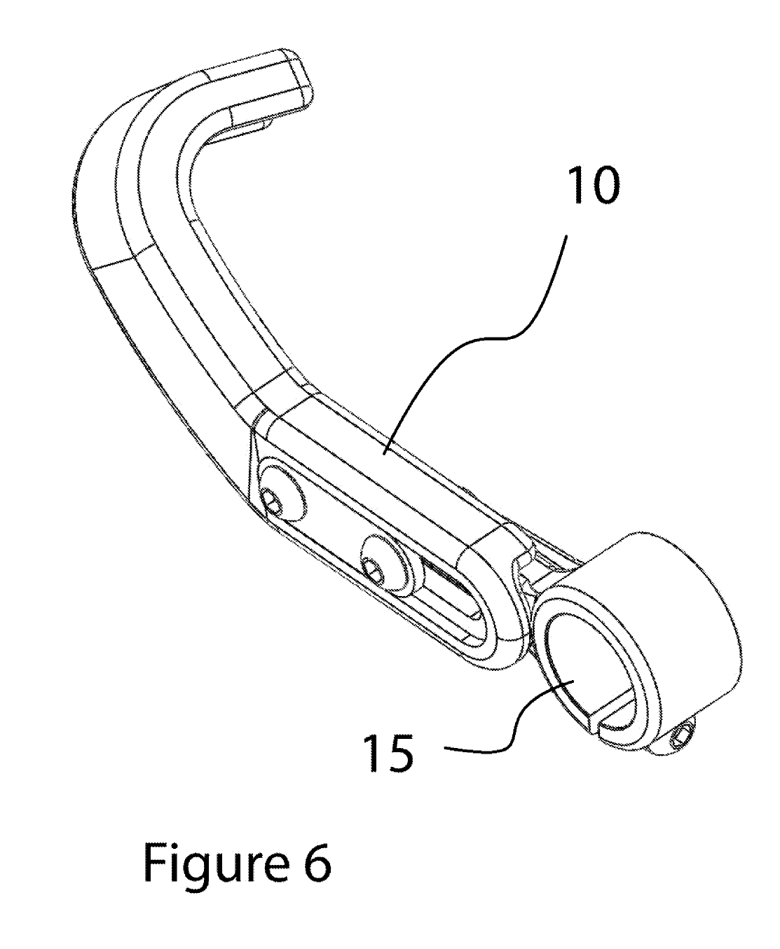

Referring to FIG. 6, the present invention may be manufactured in a variety of sizes by changing the diameter of inner surface (15) to fit different diameter handlebar (21). The length of the guard arm (10) may also be manufactured in differing lengths in order to accommodate levers of all sizes. Additionally, the guard arm (10) present invention has the ability to be bolted or fastened with fasteners (14) to the clamp (11) in several different locations in order to allow for the adjustment of the overall length of the device, effectively protecting clutch and brake levers that are located at different distances from the handlebar. These locations are preferably made available via a series of alternate bolt holes that may be alternately used to bolt the guard arm (10) to the clamp (11). Preferably, a form of washer is employed between the fasteners (14) and the guard arm (10) when the present invention is correctly mounted to the handlebar (21). The clamp (11) of the present invention, as envisioned with a inner surface (15) shaped as a cylinder (35) with a single slit to allow slight expansion of the clamp (11), may be tightened by a screw passing through two tabs (80) external to the cylinder (35) in a conventional fashion, as seen in FIG. 2.

It should also be understood that, in addition to protecting the levers (20) from accidental contact, such as during a race, the present invention can be employed to prevent damage to the motorcycle levers (20) in the event of a crash. Furthermore, the preferred embodiment of the present invention is designed to withstand damage in the event of a crash without sacrificing the capacity to dismount the present invention from the motorcycle with ease. This is in contrast to conventional lever protection guards, as the edges found on conventional lever protection guards are often destroyed during a crash, making it impossible to employ basic tools to remove the conventional lever protection guard from the handlebar of the motorcycle.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention. Any and all cosmetic changes may be made to the present invention while accomplishing the function of the present invention effectively.

Additionally, it is to be understood that the present invention is a lever protection guard to be mounted on the handlebar conventionally found on motorcycles, ATVs (All Terrain Vehicles), scooters, and other vehicles with a handlebar. It is envisioned that the present invention may be employed to guard other switches, buttons, or levers found on the handlebar as well. The preferred embodiment of the present invention is preferably composed of a durable, impact resistant material designed to withstand the force of an impact without breaking. The guard arm (10) is preferably composed of plastic, whereas the base is composed of aluminum on the preferred embodiment of the present invention; however, it is envisioned that any durable material or materials may be employed to construct the present invention. It is similarly envisioned that the present invention be capable of remaining secured to the handlebar (21) of any motorcycle, regardless of the material composition of the handlebar. Additionally, alternate embodiments of the present invention could be equipped with a locking hinge, which could facilitate the alteration of the angle of the guard arm (10) of the present invention.

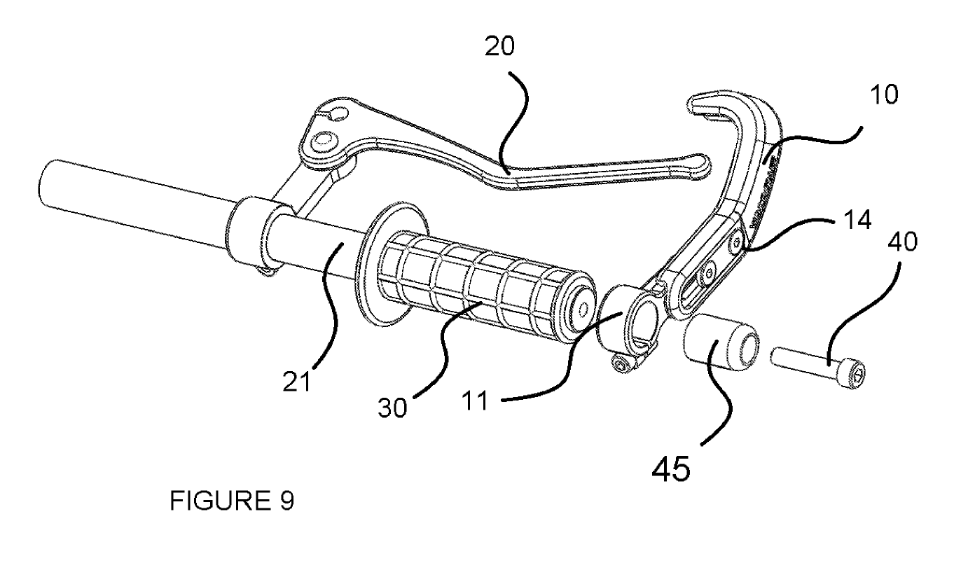

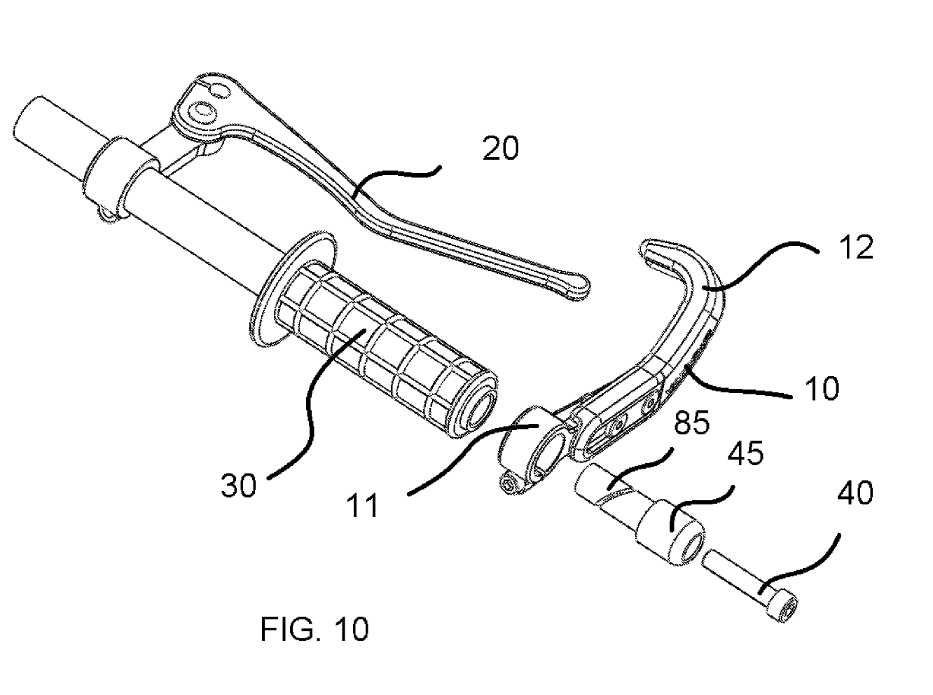

Alternate embodiments of the present invention include variations on the form of clamp (11) shaped as a cylinder, that is employed to secure the present invention to the handlebar of a motorized cycle. For example, rather than securing the clamp (11) to the handlebar of a motorized cycle via a screw passing through a tab, binding the clamp (11) closed around the handlebar (21) as employed in the preferred embodiment of the present invention, it is envisioned that the cylindrical clamp itself could be manufactured to have threading (85) on the interior surface of the cylinder (35), allowing the center extender (45) or the clamp (11) itself to screw onto certain threaded handlebars, as seen in FIG. 9. and FIG. 10. The diameter of the threaded cylinder would be determined by the target motorcycle's handlebar ID. In this embodiment, the clamp (11) of the present invention is preferably manufactured at the factory to be sized to thread onto a threaded handlebar, often provided by the OEM manufacturer, or an aftermarket handlebar setup. In some cases, the handlebars are not threaded. In this case, the center extender (45) is preferably held in place by an element that mounts inside of the inner surface (15) of the handlebar (21) by expanding within the cylinder, in order to engage the inner surface (15) of the handlebar (21), and employing friction to maintain the present invention in place. This element could be silicone or rubber based, in order to maintain the most friction possible, when expanded, to stabilize the present invention in the proper position. In all embodiments, it is to be understood that the clamp (11) of the present invention is fashioned into a cylinder (35) which is designed to fit appropriately around the exterior circumference of the cylindrical handlebar (21).

Similarly, it is envisioned that, in alternate embodiments of the present invention, the guard arm (10) may not be adjustable, but could be fixed in place. In this embodiment, there is no fastener or fasteners (14) binding the guard arm (10) to the clamp (11). Instead, the present invention is unitary, and the guard arm is integrated into the mold of the clamp (11) itself. In this embodiment, the present invention is preferably longer than the extendable embodiment of the present invention, or at the approximate length to extend beyond conventional levers (20).

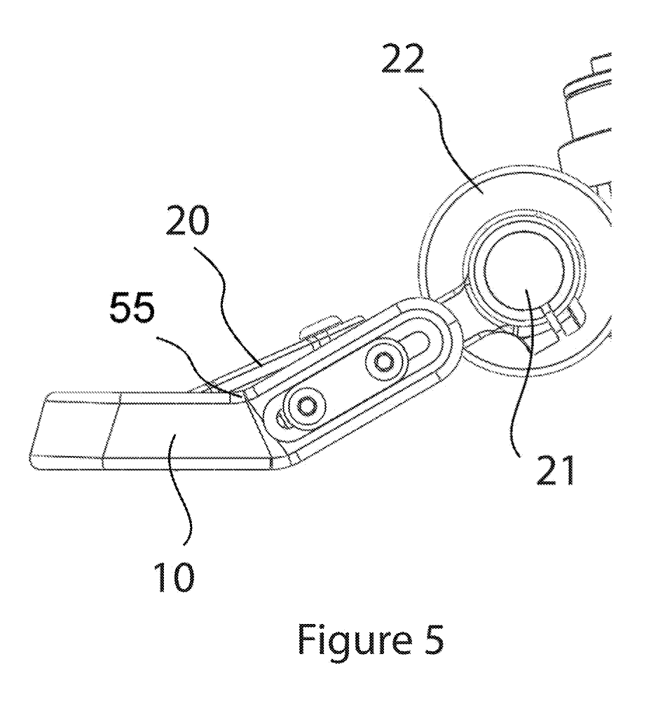

Additionally, the guard arm (10) of the present invention is envisioned to be contoured in order to shape around the levers (20) of the motorized cycle. This contoured shape is embodied by a slight hook found in the guard arm of the present invention. Additionally, the guard arm (10) preferably has a v-shape (55) as seen in FIG. 5, when viewed from the side.

An additional embodiment of the present invention features a clamp (11) with an inner surface shaped as a cylinder (35), which is held in place on the handlebar (21) via a center extender (45) that is engaged to the inside diameter of the handlebar, and is then placed through the clamp. This center extender (45), shown in FIG. 9, acts as a handlebar extension. A bolt (40) is then affixed to the inner surface (15) of the cylinder (35) by passing through the center extender (45) and conventionally screwing into the handlebar (21). This attachment method for the present invention is advantageous for motorized cycles having a handlebar that is shorter in length than traditional handlebars, thus having less free space for attachments such as the present on the handlebar (21) itself.

It should be noted that the present invention is preferably shaped such that the present invention does not interfere with operation of the cycle. It is to seem invisible, while still serving its function. It is for this reason that the present invention is preferably shaped with a v-shape (55) along the guard arm (10).

It is to be understood that the present invention is not limited to the embodiments as described above. It should be understood that there may be variations in the present invention that are not limited to the detailed description of the embodiment, but still capture the essence of the invention as dictated in the following claims.

I claim:

1) A lever protection guard for the handlebar of motorized cycles comprising:
a clamp, said clamp having a cylindrical interior sidewall; and
a guard arm, said guard arm in communication with said clamp.

2) The lever protection guard for the handlebar of motorized cycles of claim 1, wherein said guard arm has a V-shape.

3) The lever protection guard for the handlebar of motorized cycles of claim 1, wherein said clamp has an open first end and an open second end.

4) The lever protection guard for the handlebar of motorized cycles of claim 1, wherein said first end of the clamp is open.

5) The lever protection guard for the handlebar of motorized cycles of claim 4, wherein said second end of the clamp is open.

6) The lever protection guard for the handlebar of motorized cycles of claim 5, wherein said clamp is configured to receive the handlebar through the first end, and configured to allow the handlebar to exit from the second end.

7) The lever protection guard of claim 1, further comprising a hook on one end of said guard arm.

8) The lever protection guard of claim 4, wherein said guard arm has a hook that points towards the center of the handlebar when said clamp is in communication with the handlebar.

9) The lever protection guard of claim 1, wherein said clamp is secured to the outer surface of the handlebar, allowing the handlebar to protrude past the clamp.

10) The lever protection guard of claim 1, wherein said guard arm is adjustable in length.

11) The lever protection guard of claim 5, wherein said clamp is expandable.

12) A lever protection guard for the handlebar of motorized cycles comprising:
a clamp, said clamp configured to receive the handlebar and
a guard arm, extending from said clamp.

13) The lever protection guard of claim 11, wherein said clamp has a sidewall that forms a cylinder.

14) The lever protection guard of claim 11, wherein said guard arm is expandable.

15) The lever protection guard of claim 11, wherein said guard arm is secured to said clamp via a fastener.

16) The lever protection guard of claim 14, wherein said fastener is configured to secure said guard arm to said clamp in a multitude of positions.

17) The lever protection guard of claim 15, wherein length of said guard arm is configured to vary depending upon position of said guard arm relative to said clamp.

18) The lever protection guard of claim 12, wherein said cylinder has a threaded interior sidewall.

19) The lever protection guard of claim 12, wherein said guard arm and said clamp are molded together and unitary.

20) A lever protection guard for the handlebar of motorized cycles comprising:
a clamp, said clamp configured to receive the handlebar;
a guard arm, extending from said clamp;
a screw, securing said clamp to said guard arm;
wherein said guard arm is extendable;
wherein said clamp is cylindrical;
wherein said clamp has an open first end and an open second end; and
wherein said clamp is configured to receive the handlebar through the open first end, and configured to allow the handlebar to exit from the open second end.
